(19) United States
(12) Patent Application Publication
(10) Pub. No.: US 2006/0230245 A1
(43) Pub. Date: Oct. 12, 2006

(54) Data storage safety indicator and expander

(75) Inventors: Alexander G. Gounares, Kirkland, WA (US); Ashok Kuppusamy, Seattle, WA (US); John R. Douceur, Bellevue, WA (US); Patrick E. Bozeman, Sammamish, WA (US); Raymond E. Endres, Seattle, WA (US); William J. Bolosky, Issaquah, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/101,589

(22) Filed: Apr. 8, 2005

(51) Int. Cl. G06F 12/00

(52) U.S. Cl. 711/170

(57) ABSTRACT

The safety of data stored across distributed storage resources may be dynamically monitored and indicated to the user. Monitoring may occur in real time and/or in response to changes in the stored data. The notification may be in the form of, e.g., a visual indicator that appears in the taskbar of a graphical user interface of an operating system. The indicator may be presented in a particular color or having some other visual property associated with the particular data safety state. In addition, the user may be provided with a convenient way of obtaining additional storage resources. Upon automatically detecting that storage is running low, the user may be presented with a user interface that offers the user a way to easily add to the existing storage. For example, the user may be directed to a predefined Internet web site that is known to offer such additional storage.

### FIELD OF THE INVENTION

The present invention relates generally to computer storage, and specifically to monitoring, notifying, and provisioning of data-storage that use replication to provide data safety.

### BACKGROUND OF THE INVENTION

As the costs of storage decreases and the availability of networking increases, users are more likely to store their data across a set of distributed storage resources. For example, users may store their data locally in one or more separate devices and/or remotely using one or more hosted storage facilities or services. The advantage of storing data in more than one location is that the data is more likely to be available at the time that it is requested. A further advantage of storing data in more than one location is that the data is more likely to survive a hard failure of one or more storage devices, storage systems, or storage sites. Herein, we refer to the quantified availability and failure resilience of replicated data as the “safety level” of the data. Various services exist to synchronize and backup data across multiple storage resources. However, such services typically do not provide a way of monitoring the safety level of data or automatically notify the user of the safety level. In addition, such services typically do not provide a convenient way for the user to seamlessly add additional storage resources as needed when current storage resources become low. Accordingly, there is a need for such features.

### SUMMARY OF THE INVENTION

Aspects of the present invention are directed to dynamically monitoring the safety of a user's data stored across a distributed network of storage resources. Such monitoring may occur in real time and/or in response to changes in the stored data. As data is made safer, such as by replicating the data onto additional storage resources, the monitoring may detect that the data is being placed into a safer storage state.

Further aspects of the present invention are directed to providing a user interface wherein the user is dynamically notified of the safety of the data. As the data safety state is updated, so is the notification to the user. The notification may be in the form of, e.g., a visual indicator that appears in the taskbar of a graphical user interface of an operating system. The indicator may be presented in a particular color or having some other visual property associated with the particular data safety state.

Still further aspects of the present invention are directed to providing the user with a convenient way of obtaining additional storage resources. Upon automatically detecting that storage is running low, the user may be presented with a user interface that offers the user a way to easily add to the existing storage. For example, the user may be directed to a predefined Internet web site that is known to offer such additional storage. The additional storage may in any form such as remotely hosted cloud storage or local storage devices for shipment to the user and locally added to the user's computer. The additional storage may then be seamlessly added to the existing storage resources.

These and other aspects of the invention will be apparent upon consideration of the following detailed description of illustrative embodiments.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 is a functional block diagram of an illustrative computer that may be used to implement various aspects of the present invention.

FIG. 2 is a functional block diagram of an illustrative computer network.

FIG. 3 is a flowchart showing illustrative steps that may be taken to perform various aspects of the present invention.

FIG. 4 is a partial screenshot of a graphical user interface showing a data state indicator where the data is currently unsafe but being replicated.

FIG. 5 is a partial screenshot of a graphical user interface showing a data state indicator where the data is currently safe.

FIG. 6 is a partial screenshot of a graphical user interface showing a data state indicator where the data is currently unsafe.

FIG. 7 is a partial screenshot of a graphical user interface showing a low storage indicator with an option to obtain additional storage.

FIG. 8 is a partial screenshot of a graphical user interface showing an indication that additional storage has been obtained and seamlessly added to existing storage resources.

### DETAILED DESCRIPTION OF ILLUSTRATIVE EMBODIMENTS

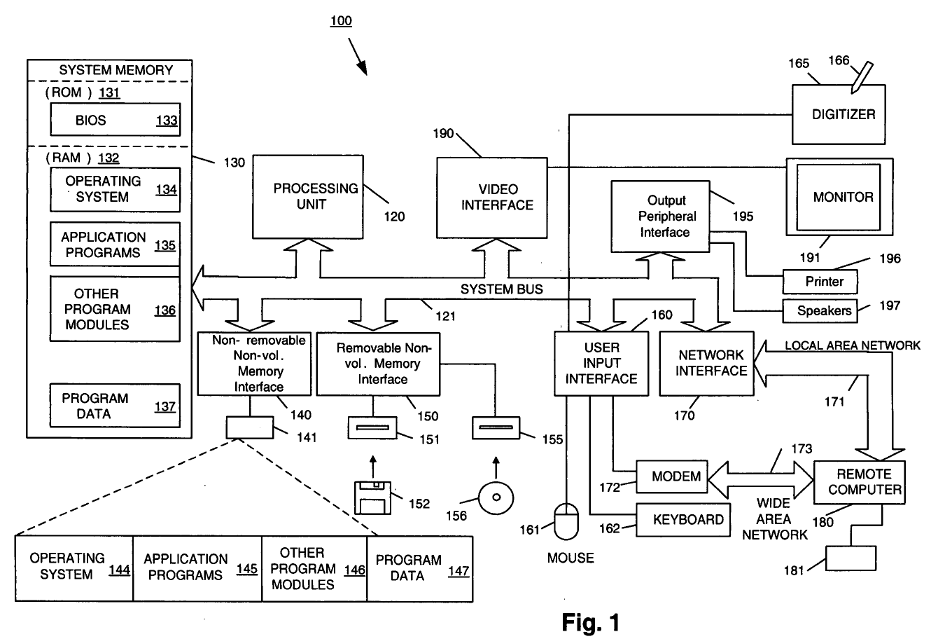

FIG. 1 illustrates an example of a suitable computing system environment 100 in which aspects of the invention may be implemented. Computing system environment 100 is only one example of a suitable computing environment and is not intended to suggest any limitation as to the scope of use or functionality of the invention. Neither should computing system environment 100 be interpreted as having any dependency or requirement relating to any one or combination of components illustrated in illustrative computing system environment 100.

The invention is operational with numerous other general purpose or special purpose computing system environments or configurations. Examples of well known computing systems, environments, and/or configurations that may be suitable for use with the invention include, but are not limited to, personal computers (PCs); server computers; hand-held and other portable devices such as personal digital assistants (PDAs), tablet PCs or laptop PCs; multiprocessor systems; microprocessor-based systems; set top boxes; programmable consumer electronics; network PCs; minicomputers; mainframe computers; distributed computing environments that include any of the above systems or devices; and the like.

Aspects of the invention may be described in the general context of computer-executable instructions, such as program modules, being executed by a computer. Generally, program modules include routines, programs, objects, components, data structures, etc. that perform particular tasks or implement particular abstract data types. The invention may also be operational with distributed computing environments where tasks are performed by remote processing devices that are linked through a communications network. In a distributed computing environment, program modules may be located in both local and remote computer storage media including memory storage devices.

With reference to FIG. 1, illustrative computing system environment 100 includes a general purpose computing device in the form of a computer 100. Components of computer 100 may include, but are not limited to, a processing unit 120, a system memory 130, and a system bus 121 that couples various system components including system memory 130 to processing unit 120. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus, also known as Mezzanine bus.

Computer 100 typically includes a variety of computer-readable media. Computer readable media can be any available media that can be accessed by computer 100 such as volatile, nonvolatile, removable, and non-removable media. By way of example, and not limitation, computer-readable media may include computer storage media and communication media. Computer storage media may include volatile, nonvolatile, removable, and non-removable media implemented in any method or technology for storage of information such as computer-readable instructions, data structures, program modules or other data. Computer storage media includes, but is not limited to, random-access memory (RAM), read-only memory (ROM), electrically-erasable programmable ROM (EEPROM), flash memory or other memory technology, compact-disc ROM (CD-ROM), digital video disc (DVD) or other optical disk storage, magnetic cassettes, magnetic tape, magnetic disk storage or other magnetic storage devices, or any other medium which can be used to store the desired information and which can accessed by computer 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF) (e.g., BLUETOOTH, WiFi, UWB), optical (e.g., infrared) and other wireless media. Any single computer-readable medium, as well as any combination of multiple computer-readable media, are both intended to be included within the scope of the term “computer-readable medium” as used herein.

System memory 130 includes computer storage media in the form of volatile and/or nonvolatile memory such as ROM 131 and RAM 132. A basic input/output system (BIOS) 133, containing the basic routines that help to transfer information between elements within computer 100, such as during start-up, is typically stored in ROM 131. RAM 132 typically contains data and/or program modules that are immediately accessible to and/or presently being operated on by processing unit 120. By way of example, and not limitation, FIG. 1 illustrates software in the form of computer-executable instructions, including operating system 134, application programs 135, other program modules 136, and program data 137.

Computer 100 may also include other computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM, DVD, or other optical media. Other computer storage media that can be used in the illustrative operating environment include, but are not limited to, magnetic tape cassettes, flash memory cards, digital video tape, solid state RAM, solid state ROM, and the like. Hard disk drive 141 is typically connected to system bus 121 through a non-removable memory interface such as an interface 140, and magnetic disk drive 151 and optical disk drive 155 are typically connected to system bus 121 by a removable memory interface, such as an interface 150.

The drives and their associated computer storage media discussed above and illustrated in FIG. 1 provide storage of computer-readable instructions, data structures, program modules and other data for computer 100. In FIG. 1, for example, hard disk drive 141 is illustrated as storing an operating system 144, application programs 145, other program modules 146, and program data 147. Note that these components can either be the same as or different from operating system 134, application programs 135, other program modules 136, and program data 137, respectively. Operating system 144, application programs 145, other program modules 146, and program data 147 are assigned different reference numbers in FIG. 1 to illustrate that they may be different copies. A user may enter commands and information into computer 100 through input devices such as a keyboard 162 and a pointing device 161, commonly referred to as a mouse, trackball or touch pad. Such pointing devices may provide pressure information, providing not only a location of input, but also the pressure exerted while clicking or touching the device. Other input devices (not shown) may include a microphone, joystick, game pad, satellite dish, scanner, or the like. These and other input devices are often coupled to processing unit 120 through a user input interface 160 that is coupled to system bus 121, but may be connected by other interface and bus structures, such as a parallel port, game port, universal serial bus (USB), or IEEE 1394 serial bus (FIREWIRE). A monitor 191 or other type of display device is also coupled to system bus 121 via an interface, such as a video interface 190. Video interface 190 may have advanced 2D or 3D graphics capabilities in addition to its own specialized processor and memory.

Computer 100 may also include a touch-sensitive device 165, such as a digitizer, to allow a user to provide input using a stylus 166. Touch-sensitive device 165 may either be integrated into monitor 191 or another display device, or be part of a separate device, such as a digitizer pad. Computer 100 may also include other peripheral output devices such as speakers 197 and a printer 196, which may be connected through an output peripheral interface 195.

Computer 100 may operate in a networked environment using logical connections to one or more remote computers, such as a remote computer 180. Remote computer 180 may be a personal computer, a server, a router, a network PC, a peer device or other common network node, and typically includes many or all of the elements described above relative to computer 100, although only a memory storage device 181 has been illustrated in FIG. 1. The logical connections depicted in FIG. 1 include a local area network (LAN) 171 and a wide area network (WAN) 173, but may also or alternatively include other networks, such as the Internet. Such networking environments are commonplace in homes, offices, enterprise-wide computer networks, intranets and the Internet.

When used in a LAN networking environment, computer 100 is coupled to LAN 171 through a network interface or adapter 170. When used in a WAN networking environment, computer 100 may include a modem 172 or another device for establishing communications over WAN 173, such as the Internet. Modem 172, which may be internal or external, may be connected to system bus 121 via user input interface 160 or another appropriate mechanism. In a networked environment, program modules depicted relative to computer 100, or portions thereof, may be stored remotely such as in remote storage device 181. By way of example, and not limitation, FIG. 1 illustrates remote application programs 182 as residing on memory device 181. It will be appreciated that the network connections shown are illustrative, and other means of establishing a communications link between the computers may be used.

As discussed previously, touch-sensitive device 165 may be a device separate from or part of and integrated with computer 100. In addition, any or all of the features, subsystems, and functions discussed in connection with FIG. 1 may be included in, coupled to, or embodied integrally as part of, a tablet-style computer. For example, computer 100 may be configured as a tablet-style computer or a handheld device such as a PDA where touch-sensitive device 165 would be considered the main user interface. In such a configuration touch-sensitive device 165 may be considered to include computer 100. Tablet-style computers are well-known. Tablet-style computers interpret gestures input to touch-sensitive device 165 using stylus 166 in order to manipulate data, enter text, create drawings, and/or execute conventional computer application tasks such as spreadsheets, word processing programs, and the like. Input may not only be made by stylus 166, but also by other types of styli such as a human finger.

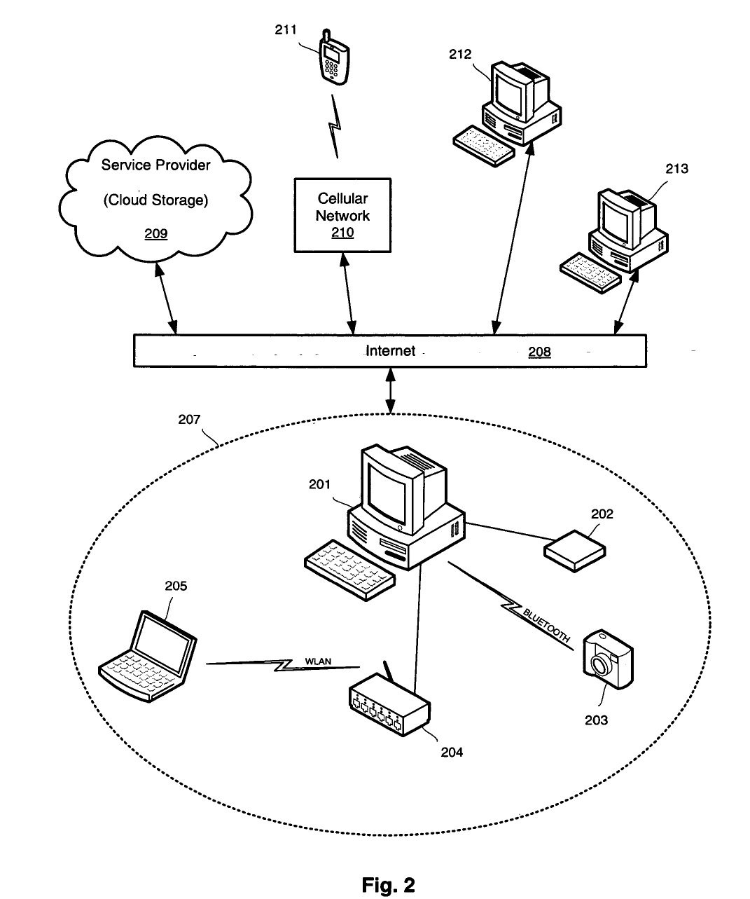

Referring to FIG. 2, an illustrative computer network is shown. As shown, a user's computer 201 is coupled to various other elements within a local area network (LAN) 207. Computer 201 may-be configured such as shown in FIG. 1, and thus may have its own on-board hard drive and/or other storage devices. Computer 201 may additionally have a locally-connected additional hard drive 202 and/or other local storage devices. For example, a digital camera 203 may be coupled to computer 201, such as via a wireless BLUETOOTH connection. From the point of view of computer 201, digital camera 203 may be considered to be a data storage device. In other words, digital camera 203 may be used to store data, such as photo files, which can be accessible by computer 201. A LAN hub 204 is also coupled to computer 201 and is the basis for the wireless portion of LAN 207. Hub 204 is wirelessly coupled with a laptop computer 205, which can also be considered a data storage device accessible by computer 201 via hub 204.

Hub 204 may further have router functionality and may couple LAN 207 with the Internet 208, such as via a cable or DSL modem (not shown). As is well known, the Internet 208 provides computer 201 with access to a wide variety of websites and services, as well as communications with other users. For example, a service provider 209 may be in the business of providing hosted data storage services to users of the Internet 208. This is also referred to herein as cloud storage, since the customer does not necessarily know or care about where his or her data is physically stored. Instead, from the customer's point of view, the data is simply stored the cloud storage service provider. Thus, the service provider 209, and not the customer, is responsible for ensuring that the customer's data is stored in accordance with the customer's requests.

Typically, service provider 209 and the customer (who in this example is the user of computer 201) have a service-level agreement that sets forth the data storage and availability requirements that are to be followed by service provider 209. For example, service provider 209 may promise to provide at least a given amount of availability to the data such that the customer can rely on being able to access his or her data when it is needed. The service-level agreement may further provide for a promise of providing an agreed-to amount of data storage. For instance, the service-level agreement may guarantee 1.0 GB of storage for the customer, with 99.999% availability assuming that the customer's own local equipment is working properly. The amount of storage reserved for the customer may be changed as desired. For instance, if the customer would like to increase the amount of available data storage, say to 2.0 GB, then the customer may request such an increase from service provider 209.

A cellular telephone and/or pager network 210 may also be coupled to the Internet 208. This allows information such as text messages to be passed between computer 201 and a cellular phone 211, which may also have an integrated personal digital assistant (PDA). In addition, as memory becomes cheaper, portable devices such as cellular phone 211 are more likely to contain substantial amounts of memory such as on removable memory cards. Thus, using appropriate software, cellular phone 211 may be viewed as another data storage device from the point of view of computer 201. In addition, various other individual users may have their own computers 212, 213 and/or LANs coupled to the Internet 208. Again, depending upon the software being used and any prior agreements between the various users, these remote computers 212, 213 may be considered data storage devices from the point of view of computer 201. Of course, many configurations other than that shown in FIG. 2 are possible.

The user of computer 201 may decide to store his or her data in a number of ways. For example, the user may decide to store only a single copy of most files, where most file are stored on the internal hard drive of computer 201, recently-taken photographs are stored on digital camera 203, extremely personal files are stored on hard drive 202 (which the user may connect and disconnect as needed), work-related files are stored on laptop computer 205, and the remaining files are stored in the cloud storage of service provider 209. This is a form of distributed storage, in that the user's data is distributed among various different storage resources.

Another way to distribute data among various storage resources is to replicate the data. In other words, it may be desirable to maintain multiple identical copies of certain data portions such as files. For example, a particular file or set of files may be stored locally such as within the internal hard drive of computer 201, and an identical copy of that file or those files may also be stored remotely such as in the cloud storage of service provider 209. Although this requires more storage than would a single copy, such replication may be desirable where there is little tolerance for data loss. Such a configuration can protect against certain data loss or unavailability scenarios. For example, if certain data is stored only locally in devices within the user's home, and if that home were destroyed by fire, then it is likely that the data will be permanently destroyed as well. Or, where certain data is stored only remotely such as in cloud storage, then loss of Internet accessibility would prevent the user from being able to access the data, at least temporarily. It should come as no surprise that both of these situations can be extremely undesirable, and in many cases users would consider such a risk intolerable.

To substantially reduce the possibility that such scenarios could result in data loss or unavailability, data may be replicated such that identical copies of the data are stored in multiple different storage resources. Thus, if one of the storage resources becomes unavailable, another one of the storage resources may be used to access data. Replication may be performed by software commonly known as a replicator. The replicator may be executed by computer 201 and/or by any other machine or entity, such as by service provider 209. When failures on different storage devices are independent, to determine the probability of failure using replicated storage on multiple storage resources, the individual probabilities of inaccessibility (such as by failure) are multiplied together. For instance, assume that it can be expected that on average the built-in hard drive of computer 201 will be unavailable one percent of the time over the next year, and that on average the cloud storage of service provider 209 will be unavailable one tenth of one percent of the time over the next year (e.g., due to inherent hard drive failure or the user's house burning down). Then, by storing identical copies on both there will be a composite unavailability over the next year of 0.01×0.001=0.001%, or only one thousandth of a percent. When failures on different storage devices are dependent, the improvement in storage safety from replication is also improved, but to a lesser extent. It can therefore be seen that the risk of data inaccessibility depends on the number of replicas of that data among different storage resources, the reliability of those storage resources themselves, and the degree of independence among storage resource failures.

Replicators are well known. In accordance with aspects of the present invention, various factors can be used by a replicator to determine when and whether to replicate a data file, as well as to where such a replication should be made. The replicator may compare these factors to a predetermined data safety policy in making such a determination. The data safety policy may define a set of thresholds, ranges, storage resource independence requirements, or other criteria that should be maintained in order to provide for an acceptable amount of data safety, or availability. For example, the data safety policy may require that at least a certain number of identical copies of each data file exist at all times on different storage resources. Or, the data safety policy may require that an identical copy of each data file always resides on the cloud storage provided by service provider 209. Or, the data safety policy may require that only certain types of files, such as those designated manually by the user or those that are automatically selected by computer 201, are always replicated so as to have at least a certain number of identical copies. In general, the data safety policy may define criteria relating to, e.g., the minimum number of replications and/or the locations of replications. In addition, the data safety policy may define static and/or dynamic criteria. Where dynamic, the criteria of the data safety policy may depend upon the historical and/or current reliability of various storage resources, the type of file being replicated, and/or any other factors. Any combination of various static and/or dynamic criteria may be defined by the data safety policy.

Thus, the safety of data may be measured against the data safety policy. At any given moment, if the data is stored in such a manner so as to meet all of the data safety policy criteria, then the data is considered safe. If the data is not stored in such a manner, then the data is considered in an unsafe state. A third state may be that the data is currently unsafe but is in the process of being replicated so as to become safe. Such a comparison may be made against all of the user's data or only a selected portion of the user's data. As will now be discussed with regard to the remaining figures, it may be desirable to indicate to the user the present safety state of the user's data. It may also be desirable to make suggestions to the user as to how to improve the safety of the data. Finally, it may be desirable to offer a convenient way to expand the user's current available data storage resources so that data safety may be more easily maintained.

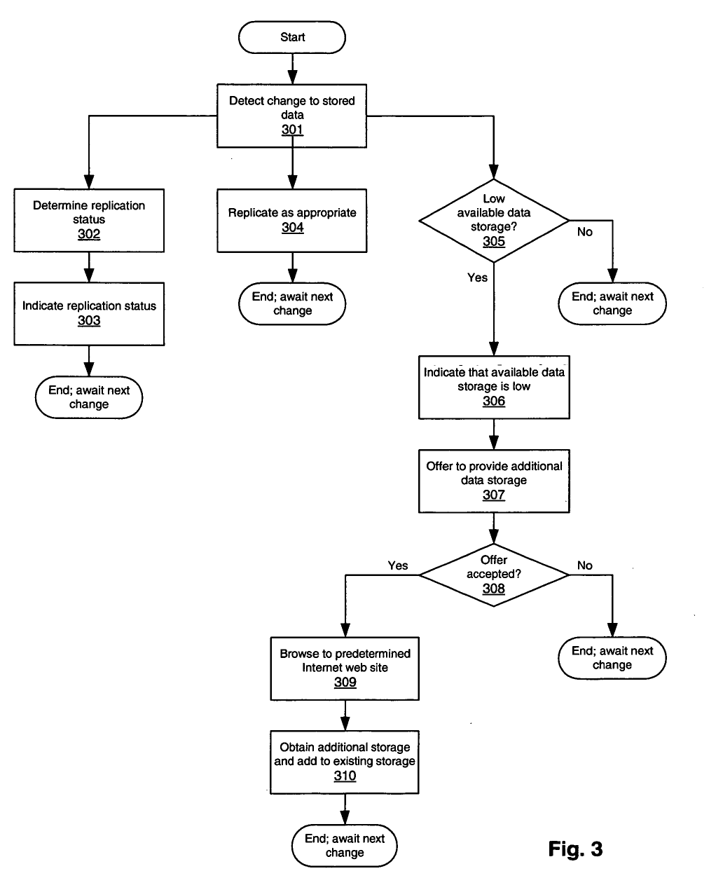

Referring to FIG. 3, an illustrative computer-implemented method is shown where data is replicated and the current safety of the data is evaluated and indicated to the user. In addition, the user may be provided with a convenient way to obtain additional storage resources. The various steps discussed herein may be implemented as computer-executable instructions stored on a computer-readable medium and executed on a computer such as computer 201 and/or a computer at service provider 209. The replicator may be located at only one computer location or it may itself be distributed. However, for purposes of explanation, it will be illustratively assumed that the replicator executes on computer 201

In step 301, it is automatically determined, without the need for user intervention, whether there has been any change to the user's stored data. For example, a stored file may have been added, deleted, or modified. As shown in FIG. 3, there are three branches extending from step 301. In the illustrative embodiment these three branches execute independently and in parallel. However, they may be executed in any manner relative to one another as desired, such as in series. Moreover, the flowcharted method of FIG. 3 may operate in the background, and, with the exception of optionally requesting user input as described herein, without the need for any user intervention. Referring to the first branch on the left side of FIG. 3, and responsive to step 301, in step 302 the replication status of the data is automatically determined. Although this determination in step 302 may be performed at any time, such as periodically, in the illustrative embodiment it is performed responsive to a change in stored data being detected. To detect the replication status, the replicator or some other software may compare the stored data with the predetermined data safety policy. Although the entire amount of stored data may be compared, it is more efficient to simply compare that portion of the data that has changed and modify if necessary the state associated with the remaining unchanged data.

If the data is determined to be safe, i.e., if the data currently satisfies the data safety policy, then an indication of this safe data state may be provided to the user. Alternatively, the data safety state may be implicitly indicated by the lack of an indicator. If the data is determined to be unsafe, i.e., if the data does not currently satisfy the data safety policy, then an indication of this unsafe data state may be provided to the user. If the data is determined to be unsafe but is in the process of being replicated so as to become safe, then an indication of this third state may be provided to the user. These three states are mutually exclusive, i.e., only one of these three states can logically exist at any given time.

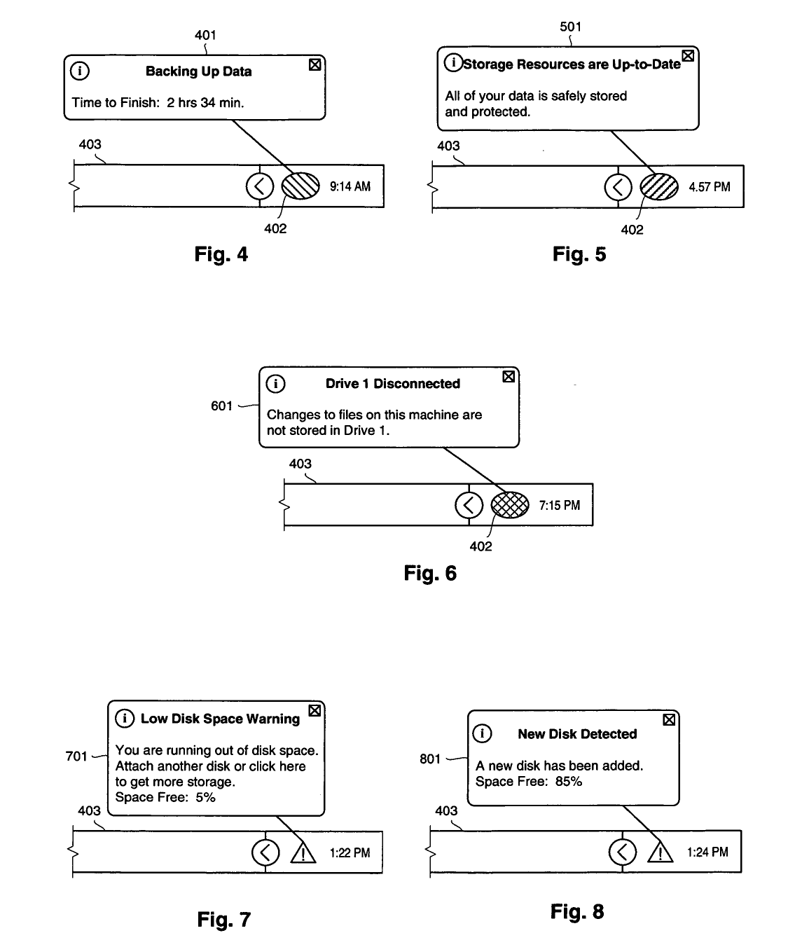

For each of these three states, the indicator may be visually displayed on a display device and/or another type of indication may be provided, such as an audible indication. For example, referring to FIG. 4, if the data is in the state of being unsafe but being replicated, then a graphical element 402 may be displayed in a particular color associated that state. In this example, the color may be yellow, as represented in FIG. 4 by reverse hatch marks. In addition or alternatively, a textual indication 401 may be provided that indicates the current data state as well as the amount of time remaining until a safe data state is attained assuming that no further changes to the data occur. Also, referring to FIG. 5, where the data is in a safe state, then the graphical element 402 may be in a different color associated with the safe state, such as green, represented in FIG. 5 by forward hatch marks. In addition or alternatively, a textual indication 501 may be provided that indicates the current data state. Referring to FIG. 6, where the data state is determined to be unsafe but not currently in the process of becoming safe, then the graphical element 402 may be displayed in yet another color associated with the unsafe data state. For example, graphical element 402 may be displayed in red, represented by cross hatch marks in FIG. 6. In addition or alternatively, a textual indication 601 may be provided that indicates the current data state and the reason for the current data state.

In FIGS. 4, 5, and 6, graphical element 402 is shown as being in a taskbar 403. A taskbar is commonly provided in graphical user interface (GUI) operating systems. Thus, in this embodiment, graphical element 402 and/or the textual indicators 401, 501, 601 (together referred to as data state indicators) are displayed independently from any other software application windows that may or may not be displayed. In other embodiments, data state indicators may be displayed on the GUI desktop other than in taskbar 403, or in a dedicated pop-up window. Alternatively, data state indicators may be provided in an application window such as an existing application window. Moreover, data state indicators may be in any form and need not be in the form illustratively shown.

Once the data safety state indicator has been presented, it may remain up for a given period of time and then disappear, or it may remain continuously displayed, such as continuously on the toolbar. In the latter case, when the data state changes, the color or other configuration (e.g., shape, size, etc.) may also dynamically change to reflect the new data state.

Referring again to FIG. 3 in the middle branch of the flowchart, responsive to detecting that stored data has changed, the replicator may automatically replicate 304 the changed data as appropriate in accordance with the data safety policy. It is possible that no replication will be necessary. Also, it may be possible that replication is necessary but not currently possible. For example, the storage resource to which replication is intended to be made may be currently unavailable (e.g., disconnected, failed, or full). The replicator may communicate the current status of replication with the portion of the computer-executable code responsible for maintaining the data state indicator.

Referring to the right-hand branch of the flowchart in FIG. 3, responsive to detecting that stored data has changed, it may automatically be determined in step 305 whether a particular data storage resource, or the sum total of all available data storage resources, is becoming full. In other words, it is determined whether there is a low amount of available data storage remaining. This may be determined by comparing the amount of remaining available data storage space with a threshold amount. The threshold amount may be fixed or may dynamically change depending upon the circumstances, and may also be defined by the data safety policy. For example, a low amount of available data storage may be considered to be any amount less than 10% of total storage resources. Of course, any other threshold may be used.

If there is still sufficient space remaining, then the right-hand branch of the flowchart ends or is repeated. However, if there is a low amount of space remaining, then the user may be notified of this fact in step 306, such as via a visual and/or audible indicator. For example, referring to FIG. 7, an indicator 701 may be presented that indicates to the user that the user is running out of space in a particular resource (in this example, disk space). In addition, in step 307 the user may be notified that additional storage is available, and the user may further be offered an opportunity to conveniently obtain such additional storage. If the offer is not accepted in step 308, then the right-hand branch ends or is repeated. However, if the offer is accepted by the user in step 308, then computer 201 may assist the user with obtaining additional storage.

For example, in FIG. 7, the user may click on indicator 701 to accept the offer of additional storage. In response, in step 309, a predetermined Internet web site may be automatically browsed to. For example, service provider 709 may have an Internet web site that sells or otherwise markets additional storage resources. Such additional storage resources may be in the form of cloud storage space or physical devices to be delivered or otherwise provided to the user, such as an additional external hard drive to be mailed to the user. Thus, in step 310, the user may obtain such additional storage as desired such as through traditional Internet purchasing schemes. Alternatively, the user may be directed to other storage resources such as other users who may be willing to provide remote storage on their respective machines (i.e., peer-to-peer storage).

Upon obtaining additional storage, the replicator may automatically begin replicating data as appropriate and/or relocating data between data resources as appropriate. In addition, the user may be notified that the new storage resources have been detected and have been seamlessly added to the existing storage resources. For example, referring to FIG. 8, an indicator 801 may be presented that indicates to the user that new disk space has been added.

Thus, various methods, apparatuses, and user interfaces have been illustratively described to provide the user with information about the current status of data stored in a distributed fashion, as well as a convenient way to obtain additional storage as needed.

What is claimed is:

1. A computer-readable medium storing computer-executable instructions for performing steps comprising:
determining whether a low amount of available data storage space exists; and
responsive to determining that the low amount of available data storage space exists, directing a user to additional data storage.

2. The computer-readable medium of claim 1, wherein the additional data storage includes cloud storage.

3. The computer-readable medium of claim 1, wherein the additional data storage includes a service that delivers a data storage physical device to the user.

4. The computer-readable medium of claim 1, wherein the step of directing includes displaying a user-selectable element that, when selected, accesses an Internet web site.

5. The computer-readable medium of claim 4, wherein the displayed element is displayed independently of any user application windows.

6. The computer-readable medium of claim 1, wherein the step of directing further includes displaying an indication representing that the low amount of available data storage space exists.

7. The computer-readable medium of claim 1, wherein the steps of determining and directing are repeated automatically without user intervention.

8. The computer-readable medium of claim 1, wherein the steps of determining and directing are performed automatically without user intervention in response to a change in an amount of available storage space.

9. The computer-readable medium of claim 1, wherein the step of determining includes determining whether the low amount of available data storage space exists in distributed storage including at least one form of storage selected from the group consisting of cloud storage via the Internet and local storage, and wherein the computer-executable instruction are further for performing steps of:
determining a replication status of data stored across the distributed storage; and
depending upon the replication status, providing to a user an indication selected from the group consisting of an indication that the data is not sufficiently replicated, an indication that the data is sufficiently replicated, and an indication that the data is currently being replicated.

10. A computer-readable medium storing computer-executable instructions for performing steps comprising:
determining a replication status of data stored across distributed storage including both cloud storage via the Internet and local storage; and
depending upon the replication status, providing to a user an indication selected from the group consisting of an indication that the data is not sufficiently replicated, an indication that the data is sufficiently replicated, and an indication that the data is currently being replicated.

11. The computer-readable medium of claim 10, wherein the step of indicating includes displaying a graphical element having a displayed configuration that depends upon the replication status.

12. The computer-readable medium of claim 11, wherein the displayed configuration is a color that depends upon the replication status.

13. The computer-readable medium of claim 11, wherein the graphical element is displayed independently of any user application windows.

14. The computer-readable medium of claim 11, wherein the graphical element is displayed in a taskbar of an operating system.

15. The computer-readable medium of claim 10, wherein the distributed storage further includes peer-to-peer storage.

16. The computer-readable medium of claim 10, wherein the step of determining includes determining whether the data is replicated so as to have at least a threshold availability.

17. The computer-readable medium of claim 10, wherein the step of determining includes determining whether the data is replicated at least a threshold number of times.

18. The computer-readable medium of claim 10, wherein the steps of determining and indicating are repeated automatically without user intervention.

19. The computer-readable medium of claim 10, wherein the steps of determining and indicating are performed automatically without user intervention in response to a change in availability of the data.

20. The computer-readable medium of claim 10, wherein the steps of determining and indicating are performed automatically without user intervention in response to a change in the data.
